(19) United States
(12) Patent Application Publication
(10) Pub. No.: US 2026/0293904 A1
(43) Pub. Date: Oct. 1, 2026

(54) Phytosanitary Composition for the Treatment of Cryptogamic Diseases Affecting Plants

(71) Applicant: Soufflet Vigne, Limas (FR)

(72) Inventors: Laurent Paupelard, Bouze-Les-Beaune (FR); Tanguy Dromard, Morières-Lès-Avignon (FR)

(21) Appl. No.: 19/476,396

(22) PCT Filed: Apr. 22, 2024
(86) PCT No.: PCT/EP2024/060960

§ 371 Date: Oct. 17, 2025

(30) Foreign Application Priority Data
Apr. 21, 2023 (FR) FR2304019

(51) Int. Cl. A01N 59/16; A01N 37/02; A01N 59/26; A01P 1/00; A01P 3/00

(52) U.S. Cl. CPC A01N 59/16; A01N 37/02; A01N 59/26; A01P 1/00; A01P 3/00

(57) ABSTRACT

The present invention relates to a phytosanitary composition comprising (i) one or more metal sources, (ii) one or more sugar(s) and/or one or more sugar derivative(s), and (iii) one or more phosphorous derivative(s).

### TECHNICAL FIELD OF THE INVENTION

The present invention relates to a phytosanitary composition comprising (i) one or more metal sources, (ii) one or more sugar(s) and/or one or more sugar derivative(s), and (iii) one or more phosphorous derivative(s). The compositions according to the invention are particularly useful as a fungicide. More particularly, another object of the invention relates to the treatment of vine mildew by application of the phytosanitary composition according to the invention.

### PRIOR ART

The invention relates to a phytosanitary composition useful as a fungicide for the preventive and/or curative treatment of cryptogamic diseases such as downy mildew.

Downy mildew is the common name for a group of cryptogamic plant diseases, particularly affecting vines and potatoes, caused by microscopic parasites classified among the Chromista phylum of the Oomycota.

It has long been known to use plant protection products based on mineral salts, oxides or hydroxides and copper sulfates, in particular for their fungicidal properties, for example against downy mildew in grapevines. These products also have a bactericidal power, for example against bacterial dieback of peach or apricot trees, Pseudomonas bacteriosis of apple or pear trees, or else a bacteriostatic power which prevents the establishment of bacterial diseases.

In particular, in the field of viticulture, common means for preventing or controlling downy mildew are, for example, copper-based products, such as copper sulfates commonly known as Bordeaux mixture, copper hydroxides, copper oxychlorides, cuprous oxides and phosphonates or phosphites. However, these products have moderate efficiency but above all copper is a powerful biocide that can lead to soil sterilization. Therefore, regulations, particularly European ones, limit the use of copper to 28 kg/ha over 7 years, or an average dose of 4 kg/ha/year of metal copper.

It should be noted that these maximum regulatory authorized copper quantities must also take into account the quantities of copper contained in certain foliar fertilizers.

There is therefore a constant need to develop new, effective and environmentally friendly phytosanitary compositions to treat cultivated plants such as grapevines.

Surprisingly, it has been discovered that the combination of (i) one or more metal oxide(s), (ii) one or more sugar(s) and/or one or more sugar derivative(s) and (iii) one or more phosphorous derivative(s) can effectively prevent and/or treat downy mildew on cultivated plants such as grapevines, while having good biocompatibility. It should also be noted that the formulation of such a combination and its phytosanitary formulation must be chemically and physically stable during storage and use.

There is therefore a constant need to develop new effective, chemically and/or physically stable phytosanitary compositions that are biocompatible and environmentally friendly for treating cultivated plants.

### SUMMARY OF THE INVENTION

A first object of the invention relates to a phytosanitary composition comprising:
(i) one or more metal sources selected from:
   a. metal oxides,
   b. metal complexes, and/or
   c. metal salts,
(ii) one or more sugar(s) and/or one or more sugar derivative(s), selected from the group consisting of: gluconic acid, fructonic acid, glucuronic acid, galactonic acid, galacturonic acid, optionally in the form of salts, and
(iii) one or more phosphorous derivative(s) selected from the group consisting of: phosphorous acid and phosphite salts.

A second object of the invention relates to a method for preparing a phytosanitary composition according to the invention, comprising a step of mixing
(i) one or more sources of metal, selected from:
   a. metal oxides,
   b. metal complexes, and/or
   c. metal salts,
(ii) one or more sugar(s) and/or one or more sugar derivative(s) selected from the group consisting of: gluconic acid, fructonic acid, glucuronic acid, galactonic acid, galacturonic acid; and
(iii) one or more phosphorous derivative(s) selected from the group consisting of: phosphorous acid and phosphite salts.

A third object of the invention relates to the use of a phytosanitary composition according to the invention, optionally prepared by a preparation method according to the invention, for the preventive and/or curative treatment of cultivated plants which may be affected by cryptogamic diseases caused by a fungus and/or oomycete.

A fourth object of the invention relates to a method for the preventive and/or curative treatment of a cryptogamic disease caused by a fungus and/or oomycete to cultivated plants comprising a step of applying a phytosanitary composition according to the invention.

### DETAILED DESCRIPTION OF THE INVENTION

For the purposes of the present invention, the various embodiments presented throughout the description may be used alone or in combination with each other, without limitation of combination.

The present invention therefore relates to a phytosanitary composition comprising:
(i) one or more metal sources selected from:
   a. metal oxides,
   b. metal complexes, and/or
   c. metal salts,
(ii) one or more sugar(s) and/or one or more sugar derivative(s), selected from the group consisting of: gluconic acid, fructonic acid, glucuronic acid, galactonic acid, galacturonic acid, optionally in the form of salts, and
(iii) one or more phosphorous derivative(s) selected from the group consisting of: phosphorous acid and phosphite salts.

If multiple sources of metal are present in the composition, the metal from the different sources may be the same or different from the other sources.

The metal may be selected from zinc, copper, iron, manganese, and aluminum, preferably the metal is selected from zinc and copper, more preferably the metal is zinc.

One or more sugars may be selected from the group consisting of: fructose, glucose, lactose, galactose, maltose or sucrose, optionally in the form of salts. Typically, salts mean a glucose salt, a lactose salt, a galactose salt, a maltose salt and/or a sucrose salt.

The term derivative in the expression “sugar derivative” means a compound obtained by chemical modification of a sugar. For example, gluconic acid is obtained by oxidation of glucose into acid. One or more sugar derivatives are selected from the group consisting of: fructonic acid, gluconic acid, glucuronic acid, galactonic acid, galacturonic acid, optionally in the form of salt(s). Typically, salts mean a fructonate salt, a gluconate salt, a glucuronate salt, a galactonate salt, a galacturonate salt.

According to a first alternative, one or more metal sources is one or more metal oxides, or metal oxides, the phytosanitary composition comprising:
(i) one or more metal oxide(s),
(ii) one or more sugar(s) and/or one or more sugar derivative(s), optionally in the form of salt(s), and
(iii) one or more phosphorous derivative(s).

One or more metal oxide(s) may be selected from the group consisting of: zinc oxide, iron oxide, manganese oxide, aluminum oxide or copper oxide. Preferably, one or more metal oxide(s) may be selected from the group consisting of: zinc oxide, iron oxide, manganese oxide. More preferably, when the metal source is a metal oxide, the metal oxide is zinc oxide. According to certain embodiments, the phytosanitary composition may comprise:
one or more metal sources selected from metal oxides selected from: zinc oxide, copper oxide, iron oxide, manganese oxide, aluminum oxide, preferably zinc oxide;
one or more sugar derivative(s), preferably gluconic acid, and
one or more phosphorous derivative(s), preferably phosphorous acid or potassium phosphite.

According to a second alternative, one or more metal sources is one or more metal complexes.

The complexes may be selected from complexes with at least one sugar derivative, as described below, or ethylenediaminetetraacetic acid (EDTA). In one embodiment, the complexes are selected from the group consisting of complexes of metals, as described below, preferably zinc, selected from complexes of said metal with ethylenediaminetetraacetic acid (EDTA).

According to a third alternative, one or more metal sources is one or more metal salts. The metal salts may be selected from the group consisting of salts of sugar derivatives, as described above, preferably gluconate; and sulfates, chlorides, carbonates and nitrates of said metal.

Salts can be selected from the group consisting of: sodium salt, zinc salt, calcium salt, silicon salt, potassium salt, manganese salt, magnesium salt, copper salt or a mixture thereof. In a particular embodiment, the salt is selected from a zinc salt and a copper salt, preferably a zinc salt. For example, a gluconate salt may be selected from the group consisting of: sodium gluconate, zinc gluconate, calcium gluconate, silicon gluconate, potassium gluconate, manganese gluconate, magnesium gluconate, copper gluconate or a mixture thereof.

Preferably, the sugar derivative in salt form is a zinc salt. In particular, the sugar derivative in salt form is zinc gluconate.

In some embodiments, the phytosanitary composition does not comprise salts of copper citrate, copper monogluconate, copper monogalacturonate, or copper sulfate.

According to certain embodiments, one or more metal sources as defined according to any embodiment above, provide up to 40 g/L of metal, preferably from 1 to 27 g/L of metal, preferably zinc. In one embodiment, preferably one or more metal sources provides from 1.5 to 5 g/L of zinc within the composition. In another embodiment, preferably one or more metal sources provides from 20 to 27 g/L of zinc within the composition. In another embodiment, preferably one or more metal sources provides from 29 to 38 g/L of zinc within the composition. The metal content can be determined by any analytical method within the knowledge of a person skilled in the art, such as for example inductively coupled plasma optical emission spectroscopy ICP-OES. In the latter case, the wavelength could be 260.2 nm to detect zinc. One or more phosphorous derivative(s) are selected from the group consisting of: phosphorous acid (H₃PO₃) also called phosphonic acid (H₃PO₃), a phosphite salt also called phosphonate salt, or a mixture thereof. Phosphite salt means a sodium phosphite (or phosphonate), a zinc phosphite (or phosphonate), a calcium phosphite (or phosphonate), a silicon phosphite (or phosphonate), a potassium phosphite (or phosphonate), a manganese phosphite (or phosphonate), a magnesium phosphite (or phosphonate) or a mixture thereof. In one embodiment, the one or more phosphorous derivative(s) are selected from the group consisting of: phosphorous acid (H₃PO₃), potassium phosphite or a mixture thereof.

Phosphorous acid is a diacid. In the context of the present invention, the expression “a phosphite salt” corresponds to both a salt of its first conjugate base H₂PO₃ and of its second conjugate base HPO₃². Preferably, it corresponds to a salt of its second conjugate base. In aqueous solution, the person skilled in the art is well aware that an acid and its conjugate base coexist at different concentrations depending on the pKa of the acid/base pair and the pH of the solution.

Without being bound by any theory, the combination of a metal source, such as zinc oxide with a sugar derivative, such as gluconic acid, and a phosphorous derivative leads to the formation of one or more active species such as zinc gluconate and/or zinc phosphite.

Advantageously, a phytosanitary composition according to the invention has improved phytosanitary efficiency as well as better performance in terms of biocompatibility and environmental friendliness for reducing and/or eliminating attacks on plants by one or more fungi and/or oomycetes. In particular, the phytosanitary composition according to the invention does not have biocidal activity, which allows to limit the environmental impact and preserve the cultivation soils. Another advantage of the phytosanitary composition according to the invention is to effectively stimulate the natural defenses of the treated plants. Advantageously, the composition according to the invention has a combination of active ingredients while maintaining its chemical and physical stability, ensuring stability during its storage and use.

The phytosanitary composition may comprise:
(i) from 1 to 40% by mass of one or more metal sources, as described according to any embodiment above;
(ii) from 5 to 50% by mass of one or more sugar derivative(s); and
(iii) from 35 to 80% by mass of one or more phosphorous derivative(s), the mass percentages being given relative to the mass of the dry composition.

Typically, the phytosanitary composition may be liquid or dry. In particular, when the composition is liquid, it further comprises water. Typically, the liquid phytosanitary composition is a solution. In some embodiments, the phytosanitary composition comprises from 10 to 50% by mass of water relative to the total mass of the composition.

According to certain embodiments, when the metal source is one or more metal oxides (metal oxide(s)), the phytosanitary composition may comprise:
one or more metal oxides selected from: zinc oxide, copper oxide, iron oxide, manganese oxide, aluminum oxide, preferably zinc oxide;
gluconic acid, and
phosphorous acid or potassium phosphite.

It may comprise:
from 2 to 25% by mass of one or more metal sources selected from metal oxides being selected from: zinc oxide, copper oxide, iron oxide, manganese oxide, aluminum oxide, preferably zinc oxide;
from 10 to 50% by mass of one or more sugar derivative(s), preferably gluconic acid, and
from 35 to 80% by mass of one or more phosphorous derivative(s), preferably phosphorous acid or potassium phosphite, the mass percentages being given relative to the mass of the dry composition.

In a particular embodiment, the phytosanitary composition may comprise:
(i) from 10 to 25% by mass of one or more metal oxide(s), preferably zinc oxide;
(ii) from 30 to 50% by mass of one or more sugar(s) and/or sugar derivative(s), preferably gluconic acid; and
(iii) from 35 to 55% by mass of one or more phosphorous derivative(s), preferably phosphorous acid;
the mass percentages being given in relation to the mass of the dry composition.

Preferably, according to this particular embodiment, the phytosanitary composition may comprise:
(i) from 14 to 22% by mass of one or more metal oxide(s), preferably zinc oxide;
(ii) from 35 to 45% by mass of one or more sugar(s) and/or sugar derivative(s), preferably gluconic acid; and
(iii) from 38 to 48% by mass of one or more phosphorous derivative(s), preferably phosphorous acid;
the mass percentages being given in relation to the mass of the dry composition.

In an exemplary embodiment, the phytosanitary composition comprises
(i) 18% by mass of one or more metal oxide(s), for example zinc oxide;
(ii) 39% by mass of one or more sugar(s) and/or sugar derivative(s), for example gluconic acid or a gluconate salt such as zinc gluconate; and
(iii) 43% by mass of one or more phosphorous derivative(s), for example phosphorous acid;
the mass percentages being given in relation to the mass of the dry composition.

When the contents are expressed in relation to the total mass of the composition, the phytosanitary composition may comprise:
(i) from 5 to 15% by mass of one or more metal oxide(s);
(ii) from 20 to 30% by mass of one or more sugar(s) and/or sugar derivative(s);
(iii) from 20 to 30% by mass of one or more phosphorous derivative(s); and
(iv) 30 to 50% by mass of water;
the mass percentages being given in relation to the total mass of the composition.

In one embodiment, the phytosanitary composition may comprise:
(i) from 8 to 12% by mass of one or more metal oxide(s);
(ii) from 22 to 26% by mass of one or more sugar(s) and/or sugar derivative(s);
(iii) from 24 to 28% by mass of one or more phosphorous derivative(s), and
(iv) 35 to 45% by mass of water;
the mass percentages being given in relation to the total mass of the composition.

In another preferred embodiment, the phytosanitary composition comprises:
(i) 11% by mass of one or more metal oxide(s), for example zinc oxide;
(ii) 24% by mass of one or more sugar(s) and/or sugar derivative(s), for example gluconic acid or a gluconate salt; and
(iii) 26% by mass of one or more phosphorous derivative(s), for example phosphorous acid;
(iv) 39% by mass of water;
the mass percentages being given in relation to the total mass of the composition.

In a second particular embodiment, the phytosanitary composition may comprise:
(i) from 2 to 10%, preferably from 3 to 6%, typically about 4% by mass of one or more metal oxide(s), preferably zinc oxide;
(ii) from 5 to 25%, preferably from 10 to 20%, typically about 17% by mass of one or more sugar derivative(s), preferably gluconic acid; and
(iii) from 60 to 80%, preferably from 64 to 75%, typically about 68% by mass of one or more phosphorous derivative(s), preferably potassium phosphite;
the mass percentages being given in relation to the mass of the dry composition.

In a third particular embodiment, the phytosanitary composition may comprise:
(i) from 1 to 5%, preferably from 3 to 5%, typically about 4% by mass of one or more metal oxide(s), preferably zinc oxide;
(ii) from 20 to 40%, preferably from 30 to 35%, typically about 31% by mass of one or more sugar derivative(s), preferably gluconic acid; and
(iii) from 40 to 60%, preferably from 45 to 55%, typically about 50% by mass of one or more phosphorous derivative(s), preferably potassium phosphite;
the mass percentages being given in relation to the mass of the dry composition.

The phytosanitary composition may further comprise an algae base that can be used as a carrier. “Algae base” means farmed, powdered marine algae, or one of their extracts or a compound extracted from these algae, for example laminarin or any other type of equivalent medium. The proportion of algae base in the composition may vary from 0 to 10% by mass, typically from 0.1 to 10% by mass.

The phytosanitary composition may also comprise any other ingredient useful in its preparation. These ingredients may be selected from thickeners such as xanthan gum, surfactants, preservatives, dispersants, wetting agents, emulsifiers, colorants or co-solvents such as propylene glycol.

According to certain embodiments, when the metal source is one or more metal complexes, the phytosanitary composition may comprise:
one or more metal complexes selected from: zinc complexes, copper complexes, iron complexes, manganese complexes, aluminum complexes, preferably zinc complexes, in particular zinc-EDTA complex;
one or more sugar derivatives, preferably gluconic acid, and
one or more phosphorous derivative(s), preferably potassium phosphite.

For example, the composition may comprise one or more metal sources selected from metal complexes selected from complexes with EDTA, preferably the complex of zinc with EDTA, gluconic acid, and potassium phosphite.

The composition may include in particular:
from 20 to 40% by mass of one or more metal sources selected from metal complexes selected from complexes with EDTA, preferably the complex of zinc with EDTA;
from 5 to 25% by mass of gluconic acid, and
from 55 to 80% by mass of potassium phosphite, the mass percentages being given relative to the mass of the dry composition.

According to certain embodiments, the composition comprises:
from 20 to 30% by mass of one or more metal sources selected from metal complexes selected from complexes with EDTA, preferably the complex of zinc with EDTA;
from 5 to 15% by mass of gluconic acid, and
from 60 to 70% by mass of potassium phosphite, the mass percentages being given relative to the mass of the dry composition.

According to certain specific embodiments, the composition comprises:
from 20 to 30%, preferably from 20 to 27%, for example about 21% about 26% by mass of the complex of zinc with EDTA;
from 6 to 12%, for example about 10% or about 6% by mass of the gluconic acid; and
from 65 to 70%, for example about 67% or 68% by mass of the potassium phosphite, the mass percentages being given relative to the mass of the dry composition.

Typically, the sum of the components of the composition described above is 100% by mass relative to the total mass of the composition.

The phytosanitary composition, when the source of the metal is one or more metal oxides, in particular zinc oxide, it may have a pH less than or equal to 6.5, preferably between 1.5 and 6, typically between 1.5 and 3.0 or between 4.5 and 5.5. In certain embodiments, the formulation further comprises at least one pH modifier selected from acids, bases or buffers, such as for example hydrochloric acid, nitric acid, phosphoric acid, maleic acid, lactic acid, potassium hydroxide or ethanolamine. In an exemplary embodiment, the phytosanitary composition, when the source of the metal is one or more metal oxides, in particular zinc oxide, may further comprise hydrochloric acid, typically in an amount ranging from 5% to 20% by mass, the mass percentages being given relative to the mass of the dry composition.

The phytosanitary composition, when the source of the metal is one or more metal complexes, in particular zinc EDTA, may have a pH greater than or equal to 4, typically between 5 and 7, typically between 5 and 6.

The phytosanitary composition may have a density less than or equal to 2.5, typically less than or equal to 2 or even less than or equal to 1.5 and for example 1.4 or 1.3.

The phytosanitary composition may have a concentration of one or more metal sources, ranging from 5 to 300 g/L. When the source of the metal is one or more metal oxides, in particular zinc oxide, the phytosanitary composition may comprise from 5 to 190 g/L of said one or more metal oxide(s), such as zinc oxide. The phytosanitary composition may have a concentration of one or more metal oxide(s), for example zinc oxide, ranging from 90 to 190 g/L, typically from 100 to 180 g/L or from 110 to 170 g/L and for example 168 g/L. According to certain embodiments, the phytosanitary composition may also have a concentration of one or more metal sources, for example one or more metal oxide(s), typically zinc oxide, ranging from 5 to 150 g/L, typically from 10 to 100 g/L, from 15 to 70 g/L or from 20 to 50 g/L and for example 30 g/L. When the source of the metal is one or more metal complexes, in particular zinc EDTA, the phytosanitary composition may also have a concentration of one or more metal sources ranging from 100 to 300 g/L, typically from 130 to 290 g/L, from 160 to 260 g/L, and for example about 200 or 150 g/L.

The phytosanitary composition may have a concentration of one or more sugar(s) and/or one or more sugar derivative(s), for example gluconic acid and/or gluconate salt(s), ranging from 110 to 250 g/L, typically from 120 to 230 g/L or from 130 to 200 g/L and preferably from 140 to 180 g/L. According to certain embodiments, the phytosanitary composition may also have a concentration of one or more sugar(s) and/or one or more sugar derivative(s), for example gluconic acid and/or gluconate salt(s), ranging from 80 to 180 g/L, typically from 90 to 170 g/L and preferably from 100 to 160 g/L, typically about 120 or 150 g/L. According to other embodiments, the phytosanitary composition may also have a concentration of one or more sugar(s) and/or one or more sugar derivative(s), for example gluconic acid and/or gluconate salt(s), ranging from 300 to 600 g/L, typically from 400 to 550 g/L and preferably from 450 to 520 g/L, typically around 490 g/L.

The phytosanitary composition may have a concentration of one or more phosphorous derivative(s), for example phosphorous acid, ranging from 180 to 1100 g/L. For example, the phytosanitary composition may have a concentration of one or more phosphorous derivative(s), for example phosphorous acid, ranging from 180 to 280 g/L, typically from 200 to 260 g/L or from 220 to 240 g/L and preferably from 225 to 235 g/L and for example 231 g/L. According to certain embodiments, the phytosanitary composition may also have a concentration of one or more phosphorous derivative(s), for example potassium phosphite, ranging from 280 to 600 g/L, typically from 350 to 560 g/L or from 400 to 540 g/L and preferably from 450 to 520 g/L and for example 490 g/L. According to other embodiments, the phytosanitary composition may also have a concentration of one or more phosphorous derivative(s), for example potassium phosphite, ranging from 600 to 1300 g/L, typically from 650 to 750 g/L or from 1000 to 1200 g/L, and for example 690 or 1100 g/L.

In one embodiment, the phytosanitary composition has one or more of the following concentrations:
(i) from 90 to 190 g/L, typically from 100 to 180 g/L or from 110 to 170 g/L of metal oxide(s), such as for example zinc oxide; and/or
(ii) from 180 to 280 g/L, typically from 200 to 260 g/L or from 220 to 240 g/L and preferably from 225 to 235 g/L of sugar(s) and/or sugar derivative(s), such as for example gluconic acid or gluconate salt; and/or
(iii) from 180 to 280 g/L, typically from 200 to 260 g/L or from 220 to 240 g/L and preferably from 225 to 235 g/L of phosphorous derivative(s), such as for example phosphorous acid.

In one embodiment, the phytosanitary composition has one or more of the following concentrations:
(i) from 5 to 150 g/L, typically from 10 to 100 g/L, from 15 to 70 g/L or from 20 to 50 g/L and for example 30 g/L, of one or more sources of metal, for example one or more metal oxide(s), such as zinc oxide; and/or
(ii) from 80 to 150 g/L, typically from 90 to 140 g/L and preferably from 105 to 135 g/L, typically about 120 g/L of sugar(s) and/or sugar derivative(s), such as for example gluconic acid or gluconate salt; and/or
(iii) from 280 to 600 g/L, typically from 350 to 560 g/L or from 400 to 540 g/L and preferably from 450 to 520 g/L and for example 490 g/L of phosphorous derivative(s), such as for example phosphorous acid or potassium phosphite.

In one embodiment, the phytosanitary composition has one or more of the following concentrations:
(i) from 100 to 300 g/L, typically from 130 to 290 g/L, from 160 to 260 g/L, and for example about 200 or 150 g/L, of one or more metal complexes, in particular zinc EDTA; and/or (ii) from 80 to 180 g/L, typically from 90 to 170 g/L and preferably from 100 to 160 g/L, typically about 120 or 150 g/L of sugar(s) and/or sugar derivative(s), such as for example gluconic acid or gluconate salt; and/or
(iii) from 600 to 1300 g/L, typically from 1000 to 1200 g/L, and for example 1100 g/L of one or more phosphorous derivative(s), for example of potassium phosphite.

In one embodiment, the phytosanitary composition has one or more of the following concentrations:
(i) from 5 to 150 g/L, typically from 10 to 100 g/L, from 15 to 70 g/L or from 20 to 50 g/L and for example 30 g/L, of one or more sources of metal, for example one or more metal oxide(s), such as zinc oxide; and/or
(ii) from 300 to 600 g/L, typically from 400 to 550 g/L and preferably from 450 to 520 g/L, typically about 490 g/L of sugar(s) and/or sugar derivative(s), such as for example gluconic acid or gluconate salt; and/or
(iii) from 600 to 1300 g/L, typically from 650 to 750 g/L, and for example 690 of one or more phosphorous derivative(s), for example of potassium phosphite.

### Preparation Method

Another aspect of the invention relates to a method for preparing a phytosanitary composition as described above.

In one embodiment, the method for preparing the phytosanitary composition comprises a step of mixing
(i) one or more sources of metal as defined above,
(ii) one or more sugar(s) and/or one or more sugar derivative(s); and
(iii) one or more phosphorous derivative(s).

In one embodiment, the method for preparing the phytosanitary composition comprises a step of mixing
(i) one or more metal oxide(s),
(ii) one or more sugar(s) and/or one or more sugar derivative(s); and
(iii) one or more phosphorous derivative(s).

The composition thus prepared can be dry or liquid depending on the packaging of each of the components.

More particularly, a method for preparing the composition, typically liquid, comprises the following steps:
(a) adding to the water one or more metal oxide(s), one or more sugar(s) and/or one or more sugar derivative(s) and one or more phosphorous derivative(s);
(b) heating at a temperature ranging from 40 to 80° C. for at least 2 hours;
(c) cooling to a temperature ranging from 15 to 25° C.

Preferably, step (a) is carried out by successive addition, preferably in this order, of one or more metal oxide(s), one or more sugar(s) and/or one or more sugar derivative(s) followed by one or more phosphorous derivative(s).

An alternative method for preparing the composition, typically liquid, comprises the following steps:
(a′) adding to the water:
one or more metal sources, typically metal salts, for example zinc oxide, and one or more sugar(s) and/or one or more sugar derivative(s), typically gluconic acid,
(a″) adding to the mixture of the previous step one or more phosphorous derivative(s), such as for example phosphorous acid or potassium phosphite, OR
(a′) adding to the water:
one or more phosphorous derivative(s), such as for example phosphorous acid or potassium phosphite, and one or more metal sources, typically metal salts, for example zinc oxide,
(a″) adding to the mixture of the previous step one or more sugar(s) and/or one or more sugar derivative(s), typically gluconic acid, optionally, steps (b) and/or (c).

In this alternative embodiment, steps (b) and/or (c) may be performed between steps (a′) and (a″) or after step (a″).

Typically, addition (a) to water is carried out with stirring. The same applies to steps (a′) and (a″).

The heating step (b) can be carried out for a period of at least 2 hours, typically at least 4 hours or even ranging from 2 hours to 6 hours. The temperature in step (b) can vary from 50 to 70° C.

The heating in step (b) may be carried out by any method known to the person skilled in the art.

Cooling in step (c) may be carried out by any method known to the person skilled in the art. Generally, cooling is carried out by stopping the heating in step (b) until ambient temperature is reached, for example ranging from 15 to 25° C. depending on the season.

When the phytosanitary composition further comprises an algae base such as laminarin and/or any other ingredient useful in its formulation, they may be added in one of steps (a), (a)′, (a″), (b) and/or (c), typically (a), (b) and/or (c). Typically, these additions are made with stirring. Each of these ingredients may be added separately or in the form of a mixture of these ingredients useful in the formulation, for example in the form of an aqueous solution.

The phytosanitary composition thus prepared can be stored, conventionally at room temperature, before being used.

In some embodiments, the phytosanitary composition is obtained according to the preparation method, as described above.

### Use

Another aspect of the invention relates to the use of the phytosanitary composition as described above for the preventive and/or curative treatment of cultivated plants, typically which may be affected by cryptogamic diseases of the mildew type.

Cryptogamic diseases are caused by a fungus and/or an oomycete. Commonly, the fungus and/or oomycete is/are selected from the group consisting of: Plasmopara viticola, Phytophthora infestans, Phytophthora ramorum, Phytophthora cinnamomi, Phytopthora capsici, Pseudoperonospora cubensis, Bremia lactucae, Peronospora destructor, Venturia inaequalis, Venturia carpophila, Venturia pyrina, Spilocaea oleaginea and Guignardia bidwellii.

More specifically, the crops that can be treated are selected from the group consisting of: grapevines, market garden crops, certain large-scale crops and fruit trees. Fruit trees comprise, for example, citrus fruits, pineapples, kiwis, olive trees, banana trees, stone fruits such as peaches, nectarines and apricots, or pome fruits such as apples and pears. Market garden crops comprise, for example, potatoes, beets, tomatoes, onions, garlic, peppers, eggplants, chervil, spinach, melons, leeks, lamb's lettuce, lettuce, watercress, or aromatic plants. Large-scale crops that can be treated are, for example, sugar beet cultivation. Preferably, the cultivated plant that can be treated is grapevine.

Treatment with a phytosanitary composition according to the invention can be carried out by spraying application, typically by foliar application.

Treatment with a phytosanitary composition according to the invention can be carried out by applying the composition to the leaves and/or fruits of the plant or any other areas of the plant requiring treatment.

Advantageously, the preventive treatment with the phytosanitary composition according to the invention is carried out before the appearance of cryptogamic diseases of the mildew type.

Curative treatment using the phytosanitary composition according to the invention can also be carried out as soon as cryptogamic diseases of the mildew type appear.

Advantageously, the phytosanitary composition according to the invention allows the prevention and/or reduction and/or elimination of attacks by the fungus and/or oomycete.

The phytosanitary composition according to the invention can be applied at a dose ranging from 1 to 7 L/ha, preferably from 4 to 6 L/ha.

Optionally, the phytosanitary composition according to the invention does not require any additional handling before its use. In particular, the phytosanitary composition then has a suitable concentration of each of the components to be used as is without, for example, an additional dilution step. The phytosanitary composition according to the invention, called “ready to use” phytosanitary composition, is generally intended for the treatment of a small area, typically for amateur gardeners or market gardeners.

Optionally, the phytosanitary composition according to the invention requires a dissolution and/or dilution step before its use. In particular, for professional use aimed at treating a large cultivation area, the phytosanitary composition typically has a higher concentration of components (i), (ii) and (iii) compared to a “ready-to-use” composition. In this case, the phytosanitary composition needs to be dissolved and/or diluted, for example after being introduced into a spray tank which is then filled with water.

In particular, an object of the present invention relates to the use of a phytosanitary composition as described above for the preventive and/or curative treatment of cryptogamic diseases of the mildew type.

The preventive and/or curative treatment of cultivated plants comprises the use, for example by spray application, at a dose of at least 1% by mass of phytosanitary composition, preferably at least 2% by mass, preferably ranging from 2% to 5% by mass or from 2.5% to 4.5% by mass of phytosanitary composition as described above. The application can be repeated every 6 to 14 days.

According to one embodiment, the application of the phytosanitary composition can be repeated from 2 to 10 times, typically from 4 to 8 times or from 6 to 7 times. When the application of the phytosanitary composition is repeated, each application can be separated from the next by 1 to 30 days, typically from 2 to 15 days, for example 7 days.

According to one embodiment, the application of the phytosanitary composition extends over 1 to 8 months, typically 2 to 6 months and conventionally over 3, 4 or 5 months depending on the cultivated plant treated. For example, the application can extend for salad cultivation over 4 months and for grapevine cultivation over 5 months.

According to one embodiment, the frequency of application of the phytosanitary composition varies from 0.2 to 2 times/week, typically from 0.5 to 1 time/week. The frequency of application can be adapted by a person skilled in the art depending on the climatic conditions, typically in the absence of rain, the period between two sprays is extended.

According to one embodiment, the application of the phytosanitary composition begins as soon as the first damage of said cryptogamic disease appears on said crop.

According to another embodiment, the application of the phytosanitary composition begins preventively before the appearance of the first damage of said cryptogamic disease on said crop, for example in the case of fruit crops when the climatic conditions are favorable to the appearance of said cryptogamic disease or during the period of presence of the fruits on said crop.

In one embodiment, treating or preventing a cryptogamic disease of cultivated plants comprises reducing and/or eliminating damage caused by the fungus and/or oomycete responsible for said cryptogamic disease.

The invention also relates to a method for the curative and/or preventive treatment of cryptogamic diseases, typically of the mildew type, comprising a step of applying to cultivated plants a composition as defined above.

### LIST OF FIGURES

FIG. 1: is a plan of the experimental device of the trial of the example.

FIG. 2: Defines the experimental variants of the trial of the example. The letter C corresponds to the contamination carried out on May 4, 2022. The abbreviations F1, F2, G1, G2 and G3 correspond to the leaf or bunch notations respectively. The abbreviations T1, T2, T3, T4, 5, T6, T7 correspond to the treatment number. The dates of each of these events (contamination, notation, treatment) are found on the upper timeline.

FIG. 3: is a graph representing the evolution of downy mildew symptoms on leaves in untreated controls.

FIG. 4: is a graph representing the evolution of downy mildew symptoms on grape bunches in untreated controls.

FIG. 5: is a graph representing the climatology of the trial site from Apr. 15 to Jul. 15, 2022. On the graph, the curves correspond to the variations in maximum (TMAX), average (TAVG) and minimum (TMIN) temperatures. The bars on the abscissa represent precipitation (noted rain) and the volumes of liquids supplied by the sprinkler treatments (noted sprinkling).

FIG. 6: is a graph representing the efficiency (relative values) on leaves May 30, 2022.

FIG. 7: is a graph representing the efficiency (relative values) on leaves as of Jun. 16, 2022.

FIG. 8: is a graph representing the efficiency (relative values) on bunches as of Jun. 9, 2022.

FIG. 9: is a graph representing the efficiency (relative values) on bunches as of Jun. 22, 2022.

FIG. 10: is a graph representing the efficiency (relative values) on bunches as of Jul. 7, 2022.

FIG. 11: is a graph representing the average incidence at D+3 on tobacco plants.

FIG. 12: is a graph representing the average severity (relative values) at D+3 on tobacco plants.

### EXAMPLE

The following examples illustrate particular embodiments of the invention without limiting its scope.

### Example 1

In Example 1, the terms below have the following definitions.

The terms “attack frequency” or “frequency efficiency” or “frequency” designate, in the case of foliage, the frequency of attack by downy mildew on the entire foliage corresponding to the ratio between the number of downy mildew spots observed and the number of leaves estimated per plot, expressed as a percentage.

The terms “attack frequency” or “frequency efficiency” or “frequency” designate in the case of bunches, the ratio between the number of bunches affected by downy mildew and the total number of bunches observed on the plot, expressed as a percentage.

The terms “attack intensity” or “intensity efficiency” or “intensity” designate, in the case of foliage, the ratio between the surface of the plot on which the leaves are affected by downy mildew and the surface of the entire plot observed, expressed as a percentage.

The terms “attack frequency” or “efficiency in intensity” or “intensity” designate in the case of bunches, the ratio between the surface on which the bunches are affected by downy mildew and the surface of the entire observed plot, expressed as a percentage.

### I. Experimental Conditions

### 1. Description of the Trial Plot

Grape variety: Cabernet-Sauvignon;
Plantation: 2.25 m×1 m, that is to say a theoretical density of 4 444 plants/hectare;
Training system: Bilateral cord, with 2 levels of wires (one bearing wire and 2 lifting wires).
Location: commune of Rodilhan 30230, France.

### 2. Characteristics of the Products Under Study

The products used and their application dosages are presented in Table 1 below.

TABLE 1

| | Active | Concentration | | Dose/ | | S.A./ |
|---|---|---|---|---|---|---|
| Name/code | substance(s) | in water | | hectare | | ha (g) |
| GDZ | Zinc oxide | 11.0% | weight | 2, 3 and | | 200-1000 |
| | Gluconic acid | 23.6% | weight | 4 L/ha | | |
| | Phosphorous acid | 25.7% | weight | | | |
| REDELI | Disodium phosphonate | 500 | g/L | 2.5 | L/ha | 1250 |
| ETONAN | Potassium phosphonates | 755 | g/L | 4 | L/ha | 3020 |
| AMPEXIO | Zoxamide | 24% | weight | 0.5 | kg/ha | 120 |
| | Mandipropamide | 25% | weight | | | 125 |
| PROFILER | Fluopicolide | 4.4% | weight | 3 | kg/ha | 132 |
| | Fosetyl-Al | 66.7% | weight | | | 2000 |
| ZORVEC | Oxathiapiproline | 100 | g/L | 0.4 | L/ha | 40 |
| ZELAVIN | | | | | | |
| FREGATE | Copper sulfate | 190 | g/L | 3.95 | L/ha | 750 |
| ENERVIN | Ametoctradine | 12% | weight | 2.5 | kg/ha | 300 |
| | Metiram | 44% | weight | | | 1100 |

Compositions and dosages of the products used in the trial (L/ha: liter/hectare; kg/ha: kilogram/hectare)

### 3. Experimental Device

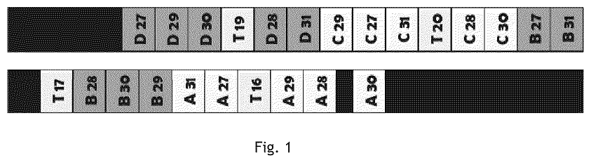

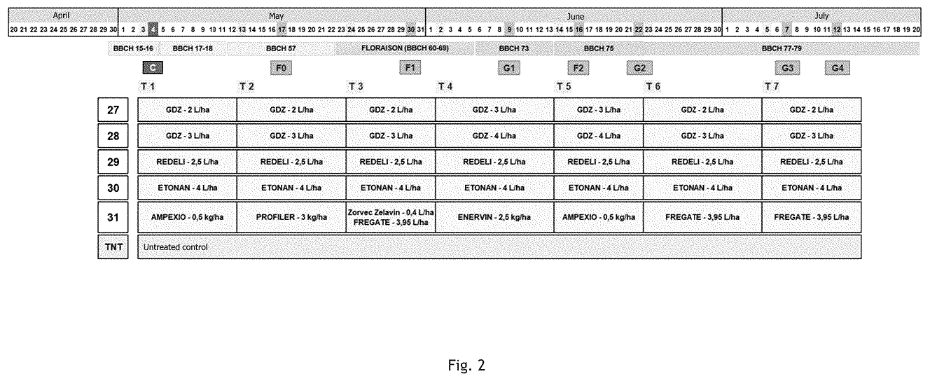

The experimental device consists of a randomized four-block device, composed of elementary plots of 10 grapevine stocks (8 of which are contaminated and observed). The device is shown in FIG. 1.

### 4. Carrying Out Treatments

All treatments were carried out in 2022. The first treatment (May 3, BBCH 15) was carried out by application using a SOLO 417 type jet backpack sprayer, at the limit of runoff (hanging drop). The following applications were made, face by face, using a STIHL SR200 type pneumatic backpack sprayer (with a theoretical volume of 100 L/ha).

TABLE 2

| | | | | Phenological |
|---|---|---|---|---|
| Treatment | | Variants | Average | stages |
| No | Date | no | volumes L/ha | (BBCH scale) |
| T1 | 3 May 2022 | 27, 28, 29, 30, 31 | 298, 296, 283, 283, 300 | 15 |
| T2 (+10 | 13 May 2022 | 27, 28, 29, 30, 31 | 99, 103, 103, 104, 103 | 57 |
| days) | | | | |
| T3 (+11 | 24 May 2022 | 27, 28, 29, 30, 31 | 105, 104, 106, 106, 100 | 61 |
| days) | | | | |
| T4 (+9 | 2 Jun. 2022 | 27, 28, 29, 30, 31 | 110, 106, 108, 100, 110 | 65 |
| days) | | | | |
| T5 (+12 | 14 Jun. 2022 | 27, 28, 29, 30, 31 | 110, 107, 104, 106, 100 | 73-75 |
| days) | | | | |
| T6 (+9 | 23 Jun. 2022 | 27, 28, 29, 30, 31 | 104, 106, 104, 104, 100 | 75-77 |
| days) | | | | |
| T7 (+12 | 5 Jul. 2022 | 27, 28, 29, 30, 31 | 101, 99, 100, 99, 100 | 77-79 |
| days) | | | | |

Spray volumes in L/ha

All application volumes in Table 2 are within +/−10% of the intended volume.

### 5. Artificial Contamination, Sprinkler Positioning and Evolution of Symptoms

Artificial contamination was implemented in the afternoon of May 4 (stage BBCH 15-16), from 4:10 p.m. to 5:15 p.m., on 6 leaves/vine stock of the 8 central grapevine stocks of each elementary plot. In order to maintain a constant humidity favorable to spore germination, sprinkling was maintained continuously from 3:00 p.m. to 10:00 p.m. for a total supply of approximately 20 mm (millimeters) of water.

First downy mildew spots were observed on May 12, 8 days after contamination. These spots were subject to a simplified notation on May 17 in the untreated controls in order to evaluate the homogeneity, in frequency, of the symptoms in the trial. This notation called F0 highlighted a repetition D behind the others with 1.4% of affected leaves (compared to respectively 3.7, 3.2 and 3.3% in repetitions A, B and C), without significant impact on the final results.

From May 13 to May 29, the positioning of around ten sprinkles (see Table 3 below) allowed a significant development, particularly in frequency, of the disease on leaves (39% observed in the controls on May 30). Massive contamination of the bunches followed with 60.5% of bunches affected in the controls on June 9, with however a moderate intensity (18.5%).

Rainfall on June 6 (for a cumulative 1.5 mm) led to a significant increase in the frequency of attacks on leaves in the controls, with 54.3% on June 16, but fairly low in intensity (with 5% compared to 2% on May 30). On these same plots, the implementation of 2 sprinkles on June 14 and 15 (4 mm/sprinkle) allowed a very strong spread of the disease on bunches both in frequency and intensity with respectively 90.5 and 36.1% on June 22.

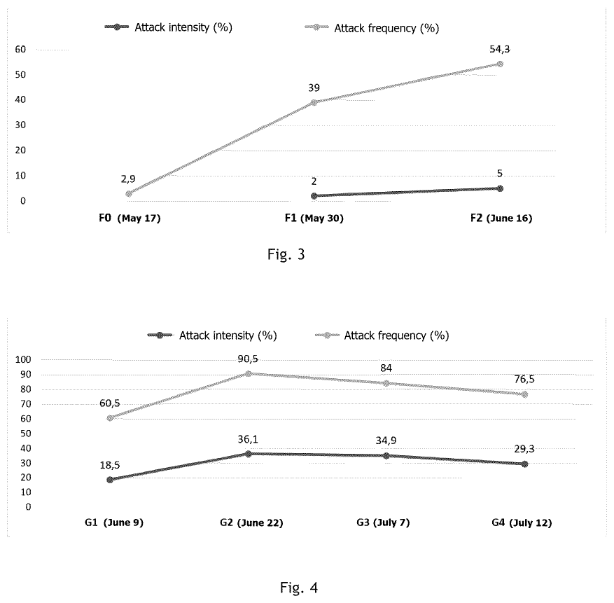

The notations (G2 and G3) carried out on bunches on Jul. 7 and 12, 2022 show a downward trend in symptoms in absolute value, despite 25.4 mm of natural precipitation recorded from Jun. 21 to Jul. 4, 2022 (see the graphs in FIG. 3 and FIG. 4).

TABLE 3

| Sprinkle | Water | Beginning | | | END | | |
|---|---|---|---|---|---|---|---|
| number | intake | Date | Hour | | Date | Hour | |
| ARTIFICIAL | 20 mm | 4 May 2022 | 3:00 | p.m. | 4 May 2022 | 10:00 | p.m. |
| CONTAMINATION | | | | | | | |
| 1 | 7 mm | 5 May 2022 | 4:00 | p.m. | 5 May 2022 | 11:00 | p.m. |
| 2 | 7 mm | 6 May 2022 | 9:30 | a.m. | 6 May 2022 | 5:30 | p.m. |
| 3 | 7 mm | 11 May 2022 | 3:00 | p.m. | 11 May 2022 | 10:00 | p.m. |
| 4 | 2 mm | 13 May 2022 | 0:00 | | 13 May 2022 | 7:00 | a.m. |
| 5 | 2 mm | 14 May 2022 | 0:00 | | 14 May 2022 | 7:00 | a.m. |
| 6 | 2 mm | 18 May 2022 | 12:30 | a.m. | 18 May 2022 | 7:30 | a.m. |
| 7 | 2 mm | 19 May 2022 | 12:30 | a.m. | 19 May 2022 | 7:30 | a.m. |
| 8 | 4 mm | 21 May 2022 | 0:00 | | 21 May 2022 | 7:00 | a.m. |
| 9 | 2 mm | 25 May 2022 | 12:05 | a.m. | 25 May 2022 | 1:20 | a.m. |
| 10 | 2 mm | 26 May 2022 | 12:05 | a.m. | 26 May 2022 | 1:20 | a.m. |
| 11 | 2 mm | 27 May 2022 | 12:05 | a.m. | 27 May 2022 | 1:20 | a.m. |
| 12 | 2 mm | 28 May 2022 | 12:05 | a.m. | 28 May 2022 | 1:20 | a.m. |
| 13 | 2 mm | 29 May 2022 | 12:05 | a.m. | 29 May 2022 | 1:20 | a.m. |

| | | | | | | |
|---|---|---|---|---|---|---|
| 14 | 4 mm | 14 Jun. 2022 | 0:00 | 14 May 2006 | 7:00 | a.m. |
| 15 | 4 mm | 15 Jun. 2022 | 0:00 | 15 Jun. 2022 | 7:00 | a.m. |

2022 Sprinkle Timeline

The sprinkles were triggered using a Bluetooth battery-powered watering programmer from brand SOLEM, WooBee model, via a solenoid valve (8 sprinkle cycles of 15 minutes for 7 mm of water, 8 sprinkle cycles of 10 minutes for 4 mm of water and 8 sprinkle cycles of 5 minutes for 2 mm of water).

### 6. Field Notations

TABLE 4

| Notation | Date | Untreated | Treated |
|---|---|---|---|
| No | (BBCH stage) | controls | variants |
| F0 | May 17 (BBCH 57) | Estimation of the attack frequency | X |
| | | on the entire foliage* | |

| | | |
|---|---|---|
| F1 | May 30 (BBCH 67) | Frequency and intensity of attack, |
| F2 | June 16 (BBCH 75) | 100 leaves/repetition |
| G1 | June 9 (BBCH 71-73) | Frequency and intensity of attack, |
| G2 | June 22 (BBCH 75-77) | 50 bunches/repetition |
| G3 | July 7 (BBCH 77-79) | |
| G4 | July 12 (BBCH 79) | |

Summary of the notations made in the field (on the 8 central grapevine stocks of each plot)
*Calculation based on the ratio between the number of downy mildew spots observed and the number of leaves estimated per plot (average of 113 leaves per grapevine stock or 904 leaves per plot of 8 grapevine stocks).

### 7. Type of Data Processing

For all the notations made, except for the notation F0 (estimation of the frequency of attack on leaves in the controls): analysis of variance (ANOVA), bilateral DUNNETT test (comparison of preparations with the reference) and NEWMAN and KEULS test at the 5% threshold (comparison of preparations with each other), after transformation into arcsin, XLSTAT software (version 2021.1.1 1080).

### 8. Climatology During the Trial

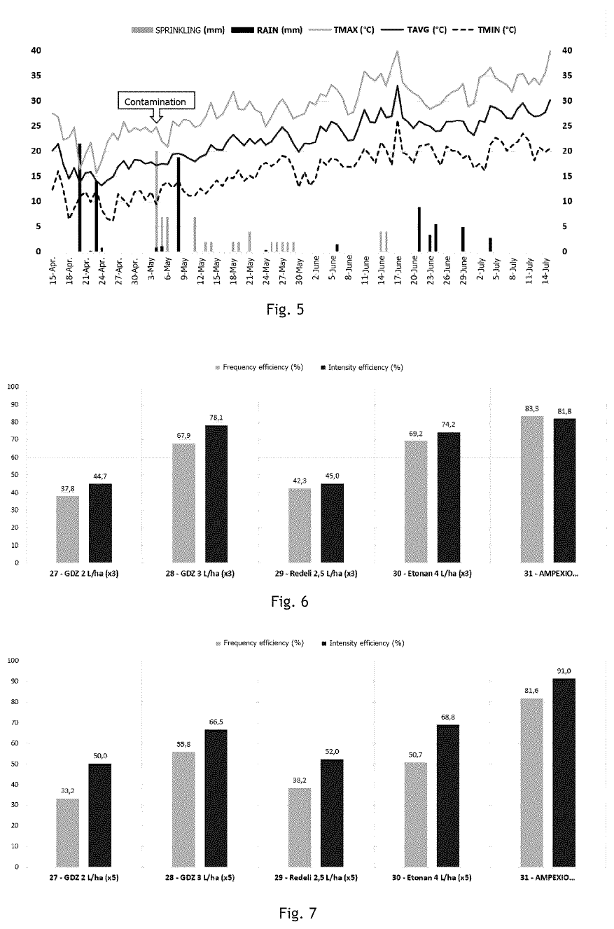

The graph in FIG. 5 represents the climatology of the trial site from Apr. 15 to Jul. 15, 2022.

The climatic period extending from May 3 (date of the first application of the products) to July 12 (date of the last notation carried out on bunches) is characterized by temperatures in line with seasonal norms throughout the month of May (20.7° C. average daily temperature), then slightly higher in June (25.4° C.) and finally particularly high throughout the first half of July with 27.4° C. average daily and maximums systematically above 33° C. (40° C. on July 15).

This period is also characterized by the low level of rainfall recorded, particularly from May 4 to June 20 with a total accumulation of 22.4 mm over 48 days (including 18.8 mm on May 8). From June 21 to July 12, the cumulative rainfall amounts to 25.4 mm over 22 days (with rainfall of 2.7 to 8.9 mm).

### 9. Cover Spray of the Trial

A cover spray treatment targets diseases other than the one being tested in the initial trials.

The cover sprays required to protect the trial against powdery mildew were carried out, as a preventive measure, on May 12 (LUNA SENSATION 0.2 L/ha) and May 25 (DYNALI 0.5 L/ha). Subsequently, no symptoms of this disease (or any other that could also interfere with downy mildew) could be observed in the trial on either leaves or bunches until the last notation was made.

### II. Field Results

The device corresponds to that provided for by the method OEPP PP 1/31(2).

### 1. Results of the Notations Made on Leaves (F1)

TABLE 5

| | | LEAVES - 1 | | | | | |
|---|---|---|---|---|---|---|---|
| | | | | Frequency | | | Intensity |
| VARIANTS | | Frequency | | Efficiency | Intensity | | Efficiency |
| (treatments carried out on this date) | | (%) | | (%) | (%) | | (%) |
| TNT | Untreated control | 39 | A | — | 2 | A | — |
| 27 | GDZ 2 L/ha × 3 | 24.3 | A | 37.8 | 1.1 | AB | 44.7 |
| 28 | GDZ 3 L/ha × 3 | 12.5 | BC | 67.9 | 0.45 | BC | 78.1 |
| 29 | REDELI 2.5 L/ha × 3 | 22.5 | B | 42.3 | 1.1 | AB | 45 |
| 30 | ETONAN 4 L/ha × 3 | 12 | BC | 69.2 | 0.53 | BC | 74.2 |
| 31 | AMPEXIO 0.5 kg/ha/ | 6.5 | C | 83.3 | 0.37 | C | 81.8 |
| | PROFILER 3 kg/ha/ | | | | | | |
| | ZORVEC ZELAVIN 0.4 L/ha + | | | | | | |
| | FREGATE 3.95 L/ha | | | | | | |

Results of notation no1 made on leaves on 30 May 2022
(flowering stage 70%, BBCH 67) - Newman & Keuls test at 5%

FIG. 6 shows the efficiencies on leaves (notation no 1, F1) on May 30, 2022.

The symptoms observed on leaves in the controls are quite moderate with 39% in frequency and 2% in attack intensity.

Analysis of the results of this first notation highlights good performance of GDZ at 3 L/ha, with respectively 67.9 and 78.1% efficiency in frequency and intensity, performance levels similar to that of ETONAN 4 L/ha (69.2 and 74.2%).

The GDZ at 2 L/ha shows a similar intensity to that of REDELI 2.5 L/ha (44.7% versus 45%).

TABLE 6

| | | LEAVES - 2 | | | | | |
|---|---|---|---|---|---|---|---|
| | | | | Frequency | | | Intensity |
| VARIANTS | | Frequency | | Efficiency | Intensity | | Efficiency |
| (treatments carried out on this date) | | (%) | | (%) | (%) | | (%) |
| TNT | Untreated control | 54.3 | A | — | 5 | A | — |
| 27 | GDZ 2 L/ha × 3/GDZ | 36.3 | B | 33.2 | 2.5 | B | 50 |
| | 3 L/ha × 2 | | | | | | |
| 28 | GDZ 3 L/ha × 3/GDZ | 24 | B | 55.8 | 1.7 | B | 66.5 |
| | 4 L/ha × 2 | | | | | | |
| 29 | REDELI 2.5 L/ha × 5 | 33.5 | B | 38.2 | 2.4 | B | 52 |
| 30 | ETONAN 4 L/ha × 5 | 26.8 | B | 50.7 | 1.6 | B | 68.8 |
| 31 | AMPEXIO 0.5 kg/ha/ | 10 | C | 81.6 | 0.4 | C | 91 |
| | PROFILER 3 kg/ha/ | | | | | | |
| | ZORVEC ZELAVIN 0.4 L/ha + | | | | | | |
| | FREGATE 3.95 L/ha/ | | | | | | |
| | ENERVIN 2.5 kg/ha/ | | | | | | |
| | AMPEXIO 0.5 kg/ha | | | | | | |

Results of notation no2 made on leaves on 16 Jun. 2022
(pea grain stage, BBCH 75) - Newman & Keuls test at 5%

FIG. 7 shows the efficiencies on the leaves (notation no 2, F2) on Jun. 16, 2022.

This second notation (F2), carried out on June 16 (17 days after F1) shows in the controls an increase in damage to the leaves, particularly in frequency (with 54.3% or +15.3 points) and to a lesser extent in intensity (5% or +3 points).

### 2. Results of the Notations Made on Bunches

TABLE 7

| | | BUNCHES - 1 | | | | | |
|---|---|---|---|---|---|---|---|
| | | | | Frequency | | | Intensity |
| VARIANTS | | Frequency | | efficiency | Intensity | | Efficiency |
| (Treatments carried out on this date) | | (%) | | (%) | (%) | | (%) |
| TNT | Untreated control | 60.5 | A | — | 18.5 | A | — |
| 27 | GDZ 2 L/ha × 3/GDZ 3 L/ha | 19.5 | BC | 67.8 | 3.2 | BC | 82.7 |
| 28 | GDZ 3 L/ha × 3/GDZ 4 L/ha | 11.5 | BC | 81 | 1.3 | CD | 93 |
| 29 | REDELI 2.5 L/ha × 4 | 36.5 | AB | 39.7 | 7.6 | B | 58.8 |
| 30 | ETONAN 4 L/ha × 4 | 20 | BC | 66.9 | 3.3 | BC | 82.4 |
| 31 | AMPEXIO 0.5 kg/ha/ | 3 | C | 95 | 0.2 | D | 99.2 |
| | PROFILER 3 kg/ha/ | | | | | | |
| | ZORVEC ZELAVIN 0.4 L/ha + | | | | | | |
| | FREGATE 3.95 L/ha/ | | | | | | |
| | ENERVIN 2.5 kg/ha | | | | | | |

Results of notation no1 made on bunches on 9 Jun. 2022
(end of fruit set/beginning of shot berry stage, BBCH 71-73) - Newman & Keuls test at 5%

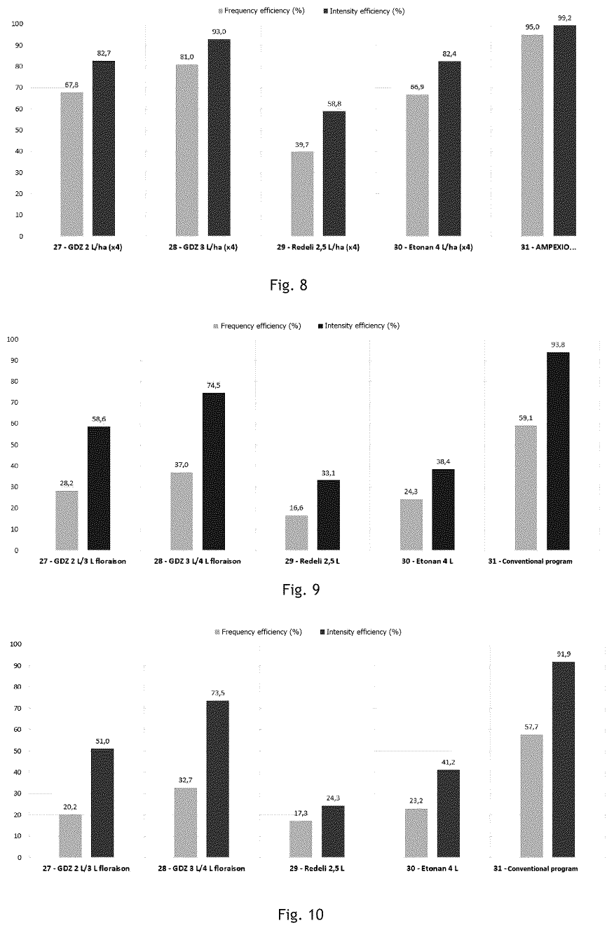

FIG. 8 shows the bunch efficiencies (notation no 1, G1) on Jun. 9, 2022.

The results of this first notation carried out on bunches highlight levels of infestation significantly higher than those observed on leaves in the controls, with 60.5% in frequency and 18.5% in attack intensity.

In this context, the GDZ at 3 L/ha then 4 L/ha is particularly effective with an efficiency of 93% on the attack intensity criterion (81% for that of frequency), that is to say at a level similar to that of the conventional program (99.2% and 95%).

The variant GDZ 2 L/ha then 3 L/ha also shows a completely satisfactory efficiency with 82.7% on this same criterion (67.8% in frequency).

TABLE 8

| | | BUNCHES - 2 | | | | | |
|---|---|---|---|---|---|---|---|
| | | | | Frequency | | | Intensity |
| VARIANTS | | Frequency | | efficiency | Intensity | | Efficiency |
| (treatments carried out on this date) | | (%) | | (%) | (%) | | (%) |
| TNT | Untreated control | 90.5 | A | — | 36.1 | A | — |
| 27 | GDZ 2 L/ha × 3/GDZ 3 L/ha × 2 | 65 | BC | 28.2 | 15 | BC | 58.6 |
| 28 | GDZ 3 L/ha × 3/GDZ 4 L/ha × 2 | 57 | C | 37 | 9.2 | C | 74.5 |
| 29 | REDELI 2.5 L/ha × 5 | 75.5 | B | 16.6 | 24.1 | B | 33.1 |
| 30 | ETONAN 4 L/ha × 5 | 68.5 | BC | 24.3 | 22.2 | B | 38.4 |
| 31 | AMPEXIO 0.5 kg/ha/ | 37 | D | 59.1 | 2.2 | D | 93.8 |
| | PROFILER 3 kg/ha/ | | | | | | |
| | ZORVEC ZELAVIN 0.4 L/ha + | | | | | | |
| | FREGATE 3.95 L/ha/ | | | | | | |
| | ENERVIN 2.5 kg/ha/ | | | | | | |
| | AMPEXIO 0.5 kg/ha | | | | | | |

Results of notation no2 carried out on bunches on 22 Jun. 2022
(end of pea-size berry stage/beginning of closure, BBCH 75-77) - Newman & Keuls test at 5%

FIG. 9 shows the bunch efficiencies (notation no 2, G2) on Jun. 22, 2022.

This second notation sees downy mildew continuing a strong expansion on the bunches with an attack frequency up 30 points (90.5%) and a near doubling of intensities (36.5%) in the control plots.

This clear worsening of parasitic pressure has led to notable drops in efficiency in non-conventional variants; however, among these variants, the variants GDZ, particularly at 3 L/ha then 4 L/ha, are those which resist it best, with, on the intensity criterion, good efficiency.

GDZ used at 2 L/ha then 3 L/ha, with 58.6% efficiency on the same intensity criterion, is more efficient than REDELI 2.5 L (33.1%) and ETONAN (38.4%) and even more efficient at 3 L/ha then 4 L/ha with 73.5% on the intensity criterion.

TABLE 9

| | | BUNCHES - 3 | | | | | |
|---|---|---|---|---|---|---|---|
| | | | | Frequency | | | Intensity |
| VARIANTS | | Frequency | | efficiency | Intensity | | Efficiency |
| (treatments carried out on this date) | | (%) | | (%) | (%) | | (%) |
| TNT | Untreated control | 84 | A | — | 34.9 | A | — |
| 27 | GDZ 2 L/ha × 3/GDZ 3 | 67 | AB | 20.2 | 17.1 | BC | 51 |
| | L/ha × 2/GDZ 2 L/ha × 2 | | | | | | |
| 28 | GDZ 3 L/ha × 3/GDZ 4 | 56.5 | B | 32.7 | 9.3 | C | 73.5 |
| | L/ha × 2/GDZ 3 L/ha × 2 | | | | | | |
| 29 | REDELI 2.5 L/ha × 7 | 69.5 | AB | 17.3 | 26.4 | AB | 24.3 |
| 30 | ETONAN 4 L/ha × 7 | 64.5 | AB | 23.2 | 20.5 | B | 41.2 |
| 31 | AMPEXIO 0.5 kg/ha/ | 35.5 | C | 57.7 | 2.8 | D | 91.9 |
| | PROFILER 3 kg/ha/ | | | | | | |
| | ZORVEC ZELAVIN 0.4 L/ha + | | | | | | |
| | FREGATE 3.95 L/ha/ | | | | | | |
| | ENERVIN 2.5 kg/ha/ | | | | | | |
| | AMPEXIO 0.5 kg/ha/ | | | | | | |
| | FREGATE 3.95 L/ha × 2 | | | | | | |

Results of notation no3 made on bunches on 7 Jul. 2022
(closing stage, BBCH 77-79) - Newman & Keuls test at 5%

FIG. 10 shows the bunch efficiencies (notation no 3, G3) on Jul. 7, 2022.

On July 7, the epidemic appeared to have been stopped by the high temperatures with stable attack frequencies (84%) and intensities (34.9%) in the untreated controls, despite a cumulative 13.8 mm of natural precipitation recorded on June 23, 24 and 29.

### III. Conclusions

The weather conditions from May to July 2022 were quite favorable for the establishment and development of downy mildew, particularly on grape bunches, with temperatures in line with or even slightly above seasonal norms and a fairly discreet drying north wind (Mistral). Only rainfall was deficient, with a near absence of precipitation during the period from May 9 to June 20, a deficit which was nevertheless able to be compensated for by the successive placement of numerous sprinklers.

The epidemic was more dynamic on bunches than on leaves, before the onset of the strong heat of July, with, in the untreated control plots, 90.5% in frequency and 36.1% in maximum attack intensity (on June 22) against respectively 54.3% and 5% (on June 16).

On leaves, the GDZ composition according to the invention demonstrated good efficiency, comparable to that of ETONAN and REDELI.

On bunches, the GDZ composition according to the invention at 3 and 4 L/ha proves to be even more effective with efficiencies higher than those of ETONAN and REDELI.

This trial demonstrated very good performance, particularly on bunches, of the GDZ composition according to the invention compared to compositions based on REDELI or ETONAN (phosphonates) with a similar mode of action (NDS Natural Defense Stimulator).

It is important to emphasize that no symptoms of phytotoxicity were observed in the trials with the GDZ composition according to the invention.

### Example 2

The following trials are carried out to study the stability of different compositions. The stability of each composition was evaluated under different conditions:
At room temperature for 5 days,
At low and high temperatures (about 5° C. and about 40° C.), and
Under accelerated conditions with heating/return to room temperature cycles.

TABLE 10

| | F-8 | F-12 | F-13 | F-34 | F-37 | F-38 | F-41 | GDZ-bis |
|---|---|---|---|---|---|---|---|---|
| Phosphorous acid | 36.66 | 32.31 | 41.60 | | | | | |
| K₂CO₃ | 37.56 | 33.19 | 42.72 | | | | | |
| ZnO | | 3.36 | | | | | 4.23 | 4.20 |
| Gluconic acid | | 17.68 | | 10.52 | 10.02 | 6.53 | 31.47 | 17.20 |
| ZnSO₄ hepta | 14.61 | | 15.68 | | | | | |
| Sodium heptagluconate | 11.17 | | | | | | | |
| Citric acid | | 13.46 | | | | | | |
| HCl | | | | | | | | 10.00 |
| EDTA-Zn | | | | 29.81 | 21.47 | 26.44 | | |
| Potassium phosphite | | | | 59.67 | 68.51 | 67.03 | 50.21 | 68.60 |
| Propylene glycol | | | | | | | 13.58 | |
| Xanthan Gum | | | | | | | 0.51 | |
| % Total | 100 | 100 | 100 | 100 | 100 | 100 | 100 | 100 |
| Stability | Unstable | Unstable | Unstable | Stable | Stable | Stable | Stable | Stable |
| pH | | | | 5.81 | 5.58 | 5.75 | 5.1 | 2.28 |
| Density | | | | 1.425 | 1.458 | 1.472 | 1.32 | 1.360 |

Details of the different compositions

The compositions mentioned as being unstable only have short-term stability of less than 1 hour.

### 1. Plant Material

Nicotiana benthamiana tobacco seedlings were carried out on Feb. 27, 2024 in seedling compost. The tobacco sprouts were transplanted on Mar. 4, 2024 and placed in grow tents for 3 weeks. Watering was carried out with tap water, except for one watering with fertilizer carried out 1 week after transplanting and another 3 weeks after transplanting.

### 2. Compositions Studied

The products studied are the GDZ composition of example 1, the GDZ-bis and F-41 compositions of Table 10 and the KHP composition which corresponds to a solution of pure potassium phosphite at 733 g/L.

### 3. Carrying Out Treatments

In this trial, 17 treatments were carried out as summarized in Table 11. For each condition, the treatment solution was sprayed on 9 plants (10 to 12 sprays per plant allow run-off coverage). The sprouts were placed in mini-greenhouses (without cover).

TABLE 11

| | | | Treat. | Phosphorous | Number of |
|---|---|---|---|---|---|
| | Vma | q.s. | Vol | acid equivalent | infected |
| Treatment | (μL) | (mL) | (mL) | (mg) | reps |
| H₂O Control | | | 9 | 0 | 9 |
| KHP ½ | 30.0 | 8.9700 | 9 | 14.13 | 9 |
| GDZ eq ½ | 40.4 | 8.9596 | 9 | 14.13 | 9 |
| GDZ-bis eq ½ | 49.2 | 8.9508 | 9 | 14.13 | 9 |
| F-41 eq ½ | 59.5 | 8.9405 | 9 | 14.13 | 9 |
| KHP ¼ | 15.0 | 8.9850 | 9 | 7.07 | 9 |
| GDZ eq ¼ | 20.2 | 8.9798 | 9 | 7.07 | 9 |
| GDZ-bis eq ¼ | 24.6 | 8.9754 | 9 | 7.07 | 9 |
| F-41 eq ¼ | 29.8 | 8.9702 | 9 | 7.07 | 9 |
| KHP ⅕ | 12.0 | 8.9880 | 9 | 5.65 | 9 |
| GDZ eq ⅕ | 16.1 | 8.9839 | 9 | 5.65 | 9 |
| GDZ-bis eq ⅕ | 19.7 | 8.9803 | 9 | 5.65 | 9 |
| F-41 eq ⅕ | 23.8 | 8.9762 | 9 | 5.65 | 9 |
| KHP ⅙ | 10.0 | 8.9900 | 9 | 4.71 | 9 |
| GDZ eq ⅙ | 13.5 | 8.9865 | 9 | 4.71 | 9 |
| GDZ-bis eq ⅙ | 16.4 | 8.9836 | 9 | 4.71 | 9 |
| F-41 eq ⅙ | 19.8 | 8.9802 | 9 | 4.71 | 9 |

The treatments are prepared in comparison with the maximum regulatory dose of KHP which is 4 L/ha. For example, the GDZ eq ½ treatment is a treatment at a dose equal to half the maximum regulatory dose of KHP, that is to say 2 L/ha.

### 4. Preparation of P. Capsici Suspension and Infection

Agar cubes of P. capsici cultures were introduced into Petri dishes. 10 mL of sterile reverse osmosis water were added to each dish then incubated for 1 hour at room temperature. The water was removed from each dish then 10 mL of sterile uHQ water was added. The incubation was then carried out for 2 days in the chamber at 22° C. with a photoperiod of 16 h/8 h (22° C./20° C.). After 2 days (on Mar. 27, 2024, the day of infection), the dishes were placed at 4° C. for 2 hours. The water was then collected from the 12 dishes to obtain approximately 120 mL. Counting under a microscope revealed a concentration of approximately 3500 spores/mL.

For each condition, spray with 10 to 12 sprays of the P. capsici suspension are sprayed. The trays are covered then the covers are removed 72 hours after infection.

### 5. Monitoring the Infection

At each observation time, monitoring is carried out by noting the symptoms overall (score from 1 to 10), that is to say the severity and by counting the number of leaves showing symptoms per plant out of the total number of leaves (%), that is to say the incidence.

### 6. Results

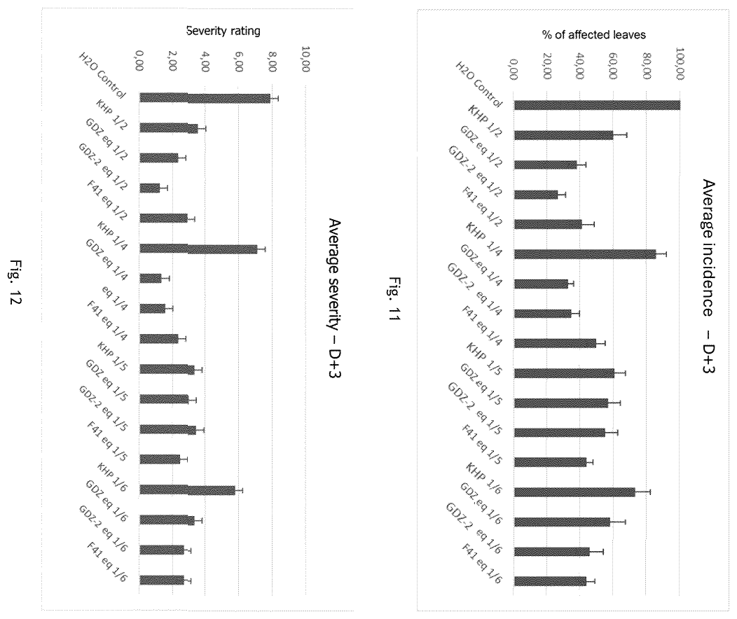

The infection is strong and rapid, in 6 days after infection the severity is comprised between 8-10 for all treatment conditions except for the GDZ-bis condition (also called GDZ-2 in FIG. 11 and FIG. 12) eq ½ for which the severity is only rated at 6.

FIG. 11 demonstrates that the mean incidence at 3 days post-infection is lower for all treatments compared to the control group. The mean incidence is significantly lower for GDZ, GDZ-bis and F-41 treatments at eq. ½ and ¼ compared to KHP. Even at lower doses (at eq. ⅕ and ⅙), GDZ-bis and F-41 treatments significantly decrease the mean incidence of infection. FIG. 12 demonstrates that the mean severity at 3 days is also reduced in the case of GDZ, GDZ-bis and F-41 treatments compared to KHP treatment.

1. A phytosanitary composition comprising:
(i) one or more metal sources selected from:
a. metal oxides,
b. metal complexes, and/or
c. metal salts,
(ii) one or more sugar(s) and/or one or more sugar derivative(s) selected from the group consisting of: gluconic acid, fructonic acid, glucuronic acid, galactonic acid, and galacturonic acid, optionally in the form of salts, and
(iii) one or more phosphorous derivative(s) selected from the group consisting of: phosphorous acid and phosphite salts.

2. The phytosanitary composition according to claim 1, wherein the one or more phosphorous derivative(s) is selected from phosphorous acid or phosphite salts selected from the group consisting of potassium phosphite, zinc phosphite, calcium phosphite, silicon phosphite, sodium phosphite, manganese phosphite, magnesium phosphite, and a mixture thereof.

3. The phytosanitary composition according to claim 1, wherein the one or more metal sources is one or more metal oxides, selected from the group consisting of: zinc oxide, copper oxide, iron oxide, manganese oxide, and aluminum oxide.

4. The phytosanitary composition according to claim 1, comprising:
(i) from 1 to 40% by mass of one or more metal sources;
(ii) from 5 to 50% by mass of one or more sugar derivative(s); and
(iii) from 35 to 80% by mass of one or more phosphorous derivative(s), the mass percentages being given relative to the mass of the dry composition.

5. The phytosanitary composition according to claim 1, comprising:
one or more metal sources selected from metal oxides selected from the group consisting of: zinc oxide, copper oxide, iron oxide, manganese oxide, and aluminum oxide;
one or more sugar derivative(s), and
one or more phosphorous derivative(s).

6. The phytosanitary composition according to claim 1, comprising:
from 2 to 25% by mass of one or more metal sources selected from metal oxides selected from the group consisting of: zinc oxide, copper oxide, iron oxide, manganese oxide, and aluminum oxide;
from 10 to 50% by mass of one or more sugar derivative(s), and
from 35 to 80% by mass of one or more phosphorous derivative(s),
the mass percentages being given relative to the mass of the dry composition.

7. The phytosanitary composition according to claim 1, comprising:
from 10 to 25% by mass of one or more metal oxide(s);
from 30 to 50% by mass of one or more sugar derivative(s); and
from 35 to 55% by mass of one or more phosphorous derivative(s),
the mass percentages being given relative to the mass of the dry composition.

8. The phytosanitary composition according to claim 1, wherein the one or more sources of metal is one or more complexes of metals selected from complexes of the metal with ethylenediaminetetraacetic acid (EDTA).

9. The phytosanitary composition according to claim 8, comprising:
one or more metal sources selected from metal complexes selected from complexes with ethylenediaminetetraacetic acid (EDTA);
gluconic acid, and
potassium phosphite.

10. The phytosanitary composition according to claim 8, comprising:
from 20 to 40% by mass of one or more metal sources selected from metal complexes selected from complexes with ethylenediaminetetraacetic acid (EDTA);
from 5 to 25% by mass of gluconic acid, and
from 55 to 80% by mass of potassium phosphite,
the mass percentages being given relative to the mass of the dry composition.

11. The phytosanitary composition according to claim 1, wherein one or more sources of metal is one or more metal salts, selected from salts of sugar derivatives, sulfates, chlorides, carbonates and nitrates of the metal.

12. The phytosanitary composition according to claim 1, further comprising at least one thickener.

13. A method for preparing a phytosanitary composition according to claim 1, comprising a step of mixing:
(i) one or more metal sources,
(ii) one or more sugar(s) and/or one or more sugar derivative(s); and
(iii) one or more phosphorous derivative(s).

14-15. (canceled)

16. A method for the preventive and/or curative treatment of a cryptogamic disease caused by a fungus and/or oomycete to cultivated plants comprising a step of applying the phytosanitary composition according to claim 1 to the cultivated plants.

17. The method according to claim 16, wherein the phytosanitary composition is applied by spraying.

18. The method according to claim 16, wherein the phytosanitary composition is applied at a dose of at least 1% by mass of phytosanitary composition.

19. The method according to claim 16, wherein the preventive and/or curative treatment of the cryptogamic disease of cultivated plants comprises reducing and/or eliminating damage caused by the fungus and/or oomycete.

20. The method according to claim 16, wherein the fungus and/or oomycete is/are selected from the group consisting of: Plasmopara viticola, Phytophthora infestans, Phytophthora ramorum, Phytophthora cinnamomi, Phytophthora capsici, Pseudoperonospora cubensis, Bremia lactucae, Peronospora destructor, Venturia inaequalis, Venturia carpophila, Venturia pyrina, Spilocaea oleaginea, and Guignardia bidwellii.

21. The phytosanitary composition according to claim 1, comprising:
zinc oxide;
gluconic acid; and/or
phosphorous acid or potassium phosphite.
